(19) United States
(12) Patent Application Publication
(10) Pub. No.: US 2014/0200855 A1
(43) Pub. Date: Jul. 17, 2014

(54) Coremicro Reconfigurable Embedded Smart Sensor Node

(71) Applicants: Stephen Oonk, Simi Valley, CA (US); Francisco J Maldonado Diaz, Simi Valley, CA (US); Anastasios Politopoulos, Simi Valley, CA (US)

(72) Inventors: Stephen Oonk, Simi Valley, CA (US); Francisco J Maldonado Diaz, Simi Valley, CA (US); Anastasios Politopoulos, Simi Valley, CA (US)

(21) Appl. No.: 14/157,511

(22) Filed: Jan. 16, 2014

Related U.S. Application Data
(60) Provisional application No. 61/849,108, filed on Jan. 17, 2013.

(51) Int. Cl. G01D 11/00

(52) U.S. Cl. CPC G01D 11/00
USPC 702/189

(57) ABSTRACT

A Coremicro Reconfigurable Embedded Smart Sensor Node has the capability of hosting intelligent algorithms to support health monitoring applications and has optional standardized software communications stack. The purpose of this present invention is to provide a flexible low power distributed computational platform to deploy intelligent software elements (based on Artificial Intelligence techniques) among the system architecture to result in a reconfigurable scheme for distributed intelligence granularity. This invention is able to be applied to a wide variety of monitoring applications either as a Standalone Smart Sensor (SSS, i.e. single Smart Sensor Node) or as a modular and scalable Smart Sensor Network configuration. Therefore, the CRE-SSN is ultra-low in power consumption, has optional pattern recognition through Artificial Neural Network, physical communication layer reconfigurable capability, has scalable communications capability, and low in weight, and optimized in size. An optional IEEE 1451 software stack is provided to manage sensors via set of standardized commands.

### CROSS REFERENCE OF RELATED APPLICATION

This is a regular application that claims the benefit of priority under 35U.S.C. §119 to a provisional application, application No. 61/849,108, filed on Jan. 17, 2013.

### STATEMENT REGARDING FEDERALLY SPONSORED RESEARCH OR DEVELOPMENT

This invention was made with Government support under Contract No. NNX10CB52C awarded by NASA Stennis Space Center, NASA Engineering and Safety Center (NESC), Building 1100, Rm 263C, MS 39529. The Government has certain rights in the invention.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a hardware implementation of Smart Sensor optimized for size, weight, and power consumption (SWaP). In health monitoring applications, in order to optimize data-acquisition and diagnostics capabilities, it is desirable that systems are capable of performing intelligent health monitoring functions (such as self-diagnostics, self-healing, calibration, and sensor data validation) to enhance system reliability and performance. Considering critical systems, it is important to embed intelligence in elements, components, subsystems, and systems within standardized frameworks. Then, in this type of applications, distributed Smart Sensor Networks provides a strategy for working with these technological challenges.

Accordingly, efficient schemes which enable fully customization (when tailoring the system to specifications) and have reconfigurable capability (once being installed) are desired features in this present invention. Especially in the aerospace industry, the above mentioned advanced technology is highly desired. The CRE-SSN provides these capabilities (where additional capabilities can be selectedly deployed in the present invention) and expands the foundation for integrating the intelligent algorithms, so as to conduct health monitoring functions within an optional standardized framework based on IEEE 1451.0 (Dot0). However, comparing with many commercial sensors on the markets, the presented invention has the better function for collecting raw data and providing version of the Dot0 stack (most of the available versions on the market only include the basic Transducer Electronic Data Sheets (TEDS) capability).

According to the strategic infrastructure of the commercial and military fields, capabilities, which have advanced sensors, data-acquisition systems, preprocessing algorithms, and diagnostics mechanisms, are required to determine the condition of the automated logistic systems. In order to achieve the above mentioned capabilities, following the Condition Based Maintenance (CBM) policies is an optimal way to establish this system. Therefore, automated logistic system is built upon CBM. In addition, an implementation strategy within the automated logistic system is based on Condition Based Maintenance Plus (CBM+) policies which comprise health monitoring, logistics, and configuration management. In other words, it can be predictable that CBM and CBM+ policies are required to combine together to support the supply chain. All these technologies are require in their architecture's lower layer, especially for the monitoring capability, smart sensors with self-identification capability is a meaningful way to benefit the overall system performance, and provide a strategy to optimize system readiness.

This invention focused on a technology which can be implemented in the low-level layer of such kind of system. The CRE-SSN has the configurable Smart Sensor functions and is designed to support a sophisticated and standardized health diagnostics system.

2. Description of Related Arts

Important advances of Smart Sensors and Networks have been achieved. For example, a lot of attention has been given to optimizing wireless communication interfaces, such as routing algorithms, recovering schemes, and the reduction of power consumption. Also, in current small size military applications, ultra-low power and low weight sensors are required for monitoring systems. And, for the corrosion monitoring, leakage detection in critical systems (such as hydraulic systems in avionics or fuel lines), and health detection for rotorcraft airframes structure, the ultra-low power and low weight sensors are required also. Accordingly, in some relevant application fields, it is important to improve sensor technologies under extreme operation conditions. The common improvements need to be achieved among these applications are: (a) design for optimizing SWaP; (b) enhancing sensor intelligence to perform health monitoring functions (system diagnostics, sensor self-diagnostics, data validation, self-healing, and calibration); (c) design for supporting the configuration management (self-identification); and (d) standardization. The CRE-SSN invention offers a set of configuration features to support these improvements.

### SUMMARY OF THE PRESENT INVENTION

A main object of the present invention is to provide a reconfigurable embedded smart sensor node capable of providing in a scalable way: (a) data acquisition capability; (b) computational power to embed preprocessing algorithms (extract features from raw data); (c) sensor self-diagnostics (for local or within the network supervisor device); (d) failure detection by Artificial Intelligence techniques; (e) self-identification; (f) in compliance with IEEE 1451. These baseline capabilities are scalable and customizable while subsets of such features can be selected for embedding within the present invention.

Another object of the present invention is to provide a reconfigurable embedded smart sensor node for achieving reconfiguration, wherein the reconfigurable embedded smart sensor node is interfacing with communication modules through serial communication profile, and is able to switch different communication modules (and then enabling infusion of different wireless communication standards) without affecting the CRE-SSN's Dot0 communication protocol. A Zigbee module is provided the baseline for interfacing within the networks (although any device with serial communication profile is a valid interface for its infusion within the sensor).

Another object of the present invention is to provide a reconfigurable embedded smart sensor node which is able to optimize the flexibility and the reconfiguration so as to enable handling different types of transducer (actuator or sensing elements, where this last is termed “sensor” according to the present invention). In particular, The CRE-SSN's sensors can be set as single sensor (i.e. only a single sensing element attached to the CRE-SSN) or sensor suite configuration (i.e. sets of homogeneous or heterogeneous sensors).

Another object of the present invention is to provide a reconfigurable embedded smart sensor node which is to embed Artificial Neural Networks that can be retrained in a central node (or host computer) and transferred to CRE-SSN through the IEEE 1451 communication protocol.

Another object of the present invention is to provide a reconfigurable embedded smart sensor which comprises a Standalone Smart Sensor (SSS) capable of hosting transducer sets (i.e. sensor suites), wherein the number of transducer sets is ≦7 (for a given set realization) and it is able to accommodate diversity of sensor types, such as homogeneous or heterogeneous type sensor suites.

Another object of the present invention is to provide a reconfigurable embedded smart sensor which comprises a Smart Sensor Network by interconnection of sets of CRE-SSN to a host computer.

Another object of the present invention is to provide a reconfigurable embedded smart sensor which comprises a distributed hardware platform capable of hosting intelligent software elements based on Artificial Neural Network.

Another object of the present invention is to provide a reconfigurable embedded smart sensor which comprises an optional standardized software communications stack to manage the internal resources, sensor suite, actuators, and Intelligent Software Elements in the CRE-SSN.

Another object of the present invention is to provide a reconfigurable embedded smart sensor which has optimized size, weight, and power (SWaP).

Another object of the present invention is to provide a reconfigurable embedded smart sensor which comprises a swappable physical communication channel in the communication software stack to enable wireless communication through different wireless standards.

Accordingly, in order to achieve the above mentioned objects, a reconfigurable embedded smart sensor node, comprising:

a communication module, a processing unit using an ultra-low-power microcontroller and complementary resources including a reconfigurable RS-232 serial port wired interface, a power management unit, and JTAG port 35;

a rich set of software resources to implement the functionalities of Network Capable Application Processor (NCAP) and Transducer Interface Module (TIM); and

a two-board stack consisting of a main board hosting digital cores; and an expansion board having a customizable signal conditioning, a plurality of sensor suite connections, an expansion bus and a communication module for baseline implementation.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a coremicro reconfigurable embedded smart sensor node according to a preferred embodiment of the present invention, illustrating the logic structure (architecture) of the CRE-SSN.

FIG. 2 is a block diagram of software architecture of a coremicro reconfigurable embedded smart sensor node according to the above preferred embodiment of the present invention.

FIG. 3a shows a block diagram of a main board for implementing the CRE-SSN according to the above preferred embodiment of the present invention.

FIG. 3b shows a block diagram of an expansion board for implementing the CRE-SSN according to the above preferred embodiment of the present invention.

FIG. 4 is a table of an expansion bus (20-pin connector) signal definition according to the above preferred embodiment of the present invention.

FIG. 5 is a table of the Baseline Set of Standard Commands Classes and Functions according to the above preferred embodiment of the present invention. (indicated as required by the IEEE 1451.0 standard).

FIG. 6 is a block diagram of operational states of the CRE-SSN (TIM) and Transducer Channels (TCh) thereof according to the above preferred embodiment of the present invention.

FIG. 7 is a block diagram of a CRE-SSN full set of triggering methods according to a preferred embodiment of the present invention.

FIG. 8 is a block diagram of a CRE-SSN Programmer's Reference Model listing the TIM's TEDS and associated registers as well as the Transducer Channel's TEDS and associated registers according to a preferred embodiment of the present invention,

FIG. 9 is a block diagram of the Multilayer Perceptron's topology (a case of Intelligent Software Element, ISE) which is executed within the CRE-SSN according to a preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

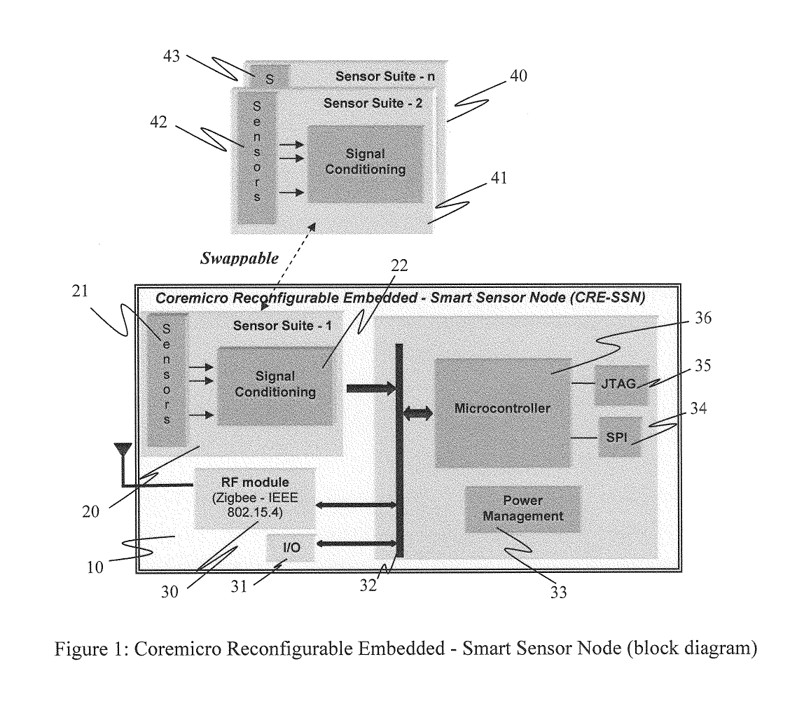

Referring to FIG. 1 to FIG. 3 of the drawings, a CRE-SSN 10 is provided according to a preferred embodiment of the present invention, wherein the CRE-SSN architecture 10 is comprised of cutting edge technologies that utilize state-of-the-art standards for a Smart Sensor realization that can perform the function of a Transducer Interface Module (TIM) and Wireless Transducer Interface Module (WTIM) as defined by the IEEE 1451.0 standard. The CRE-SSN 10 is designed to comply with IEEE 1451.0 (Dot0) for providing data acquisition, self-identification, calibration, and sensor management scheme. In such manner, architecture implementation of smart networks is enabled by providing (a) a standardized framework comprised of a rich set of software resources to implement the functionalities of Network Capable Application Processor (NCAP) 50 and a communication software stack, which is embedded as Transducer Interface Module 60 (sets) in the present invention; and (b) a CRE-SSN 10 consisting by flexible and miniaturized sensors on main sensor board 100 and expansion board 200 (two board stack, as baseline). To optimize throughput, the CRE-SSN 10 design is based on two devices: (1) a communication module 30 and (2) a processing unit using an ultra-low power microcontroller 36 as depicted in FIG. 1. Complementary resources include: (a) reconfigurable RS-232 serial port wired interface 34; (b) power management unit 33; and (c) JTAG port 35. The CRE-SSN architecture 10 allows swapping two sensor suites, 40 and 41, with the baseline 20 for system reconfiguration. Sets of sensors suites 21, 42, and 43, can be formed by same or different transducer type and up to seven sensors can be controlled through the expansion board 200 in the baseline 20 of the CRE-SSN implementation. Then sets of homogeneous or heterogeneous sensors (where each subset can include nₛ sensors, being 1≦nₛ≦7) can be configured through the Transducer Channels 70-77, by taking advantage of the communication software stack, which is embedded as Transducer Interface Module 60 and by customization of a signal conditioning 22.

The baseline implementation of the CRE-SSN architecture 10 is based on a two-board configuration consisting of: (i) Main Board 100; and (ii) Expansion Board 200.

The Main Board 100 controls the digital core consisting on: (1) an ultra-low power microcontroller MSP430F2618 106; (2) an ultra-low power RS-232 driver 107 and a 9-pin connector 103; (3) a JTAG connector 104; and (4) an expansion bus connector 105. Additionally the Main Board 100 allows for powering the CRE-SSN 10 by a battery 102 (or any power source that provides 3 volts DC), and also by AC/DC adapter where a 12 volts DC feeds a LDO Regulator 108. Connection to an LED (optional) and reset button is also provided in the Main Board 100.

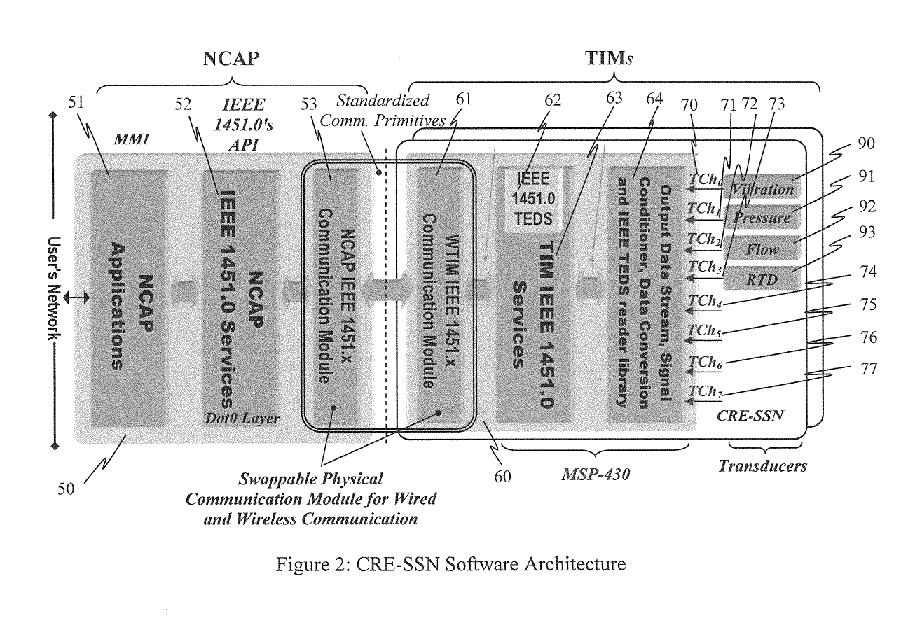

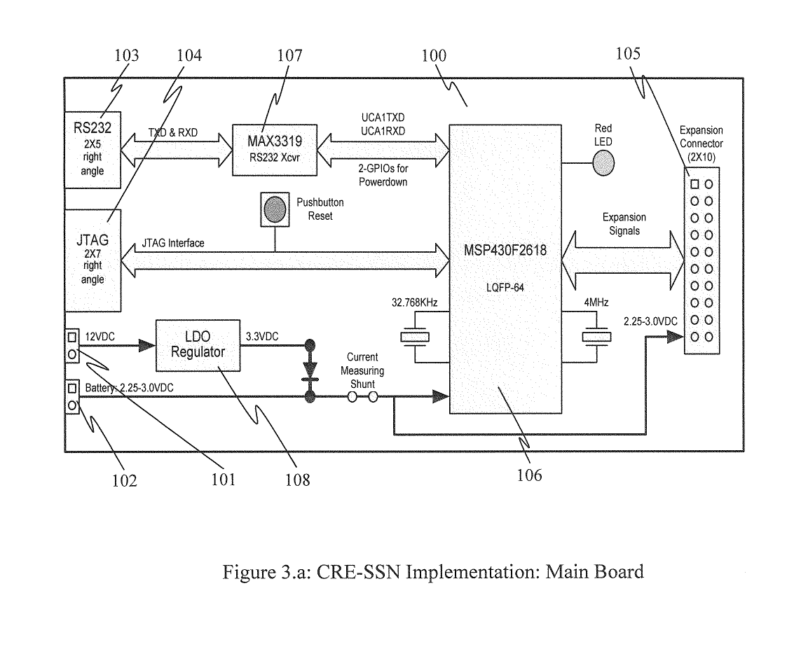

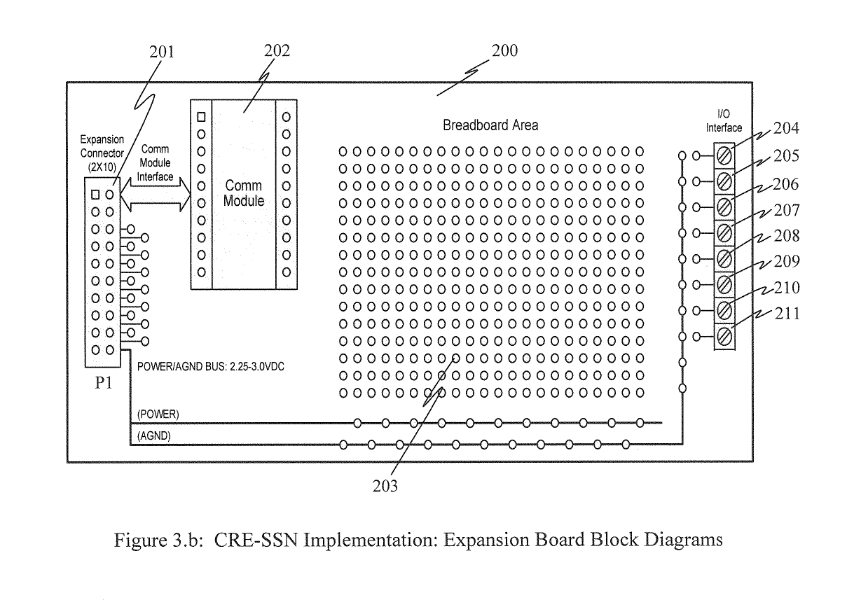

The expansion board block diagram 200, as shown in FIG. 3.b, includes customizable: (1) signal conditioning 203 (22 in FIG. 1); (2) sensor suite connections 204-211 (to integrate sensor suite functionality (21 in FIGS. 1)); and (3) communication module 202 (communication functionality 30 in FIG. 1). The customizable signal conditioning 203 and sensor suite connections 204-211 are adapted for integrating the sensor suites formed by up to seven homogeneous or heterogeneous sensor sets, which can be a vibration sensor 90, a pressure sensor 91, a flow sensor 92, and a temperature sensor 93 as exemplified in FIG. 2.

It is worth mentioning that the Transducer Interface Module 60 is able to provide a hardware capability is complemented for managing up to eight transducer channels 70-77, defined as TChₓ, “x” is from 0 to 7, and each of the transducer channel is driven by a single transducer (i.e. sensing element (sensor) or actuator)). In such manner, the sensor sets (such as: vibration 90; pressure 91; flow 92; and RTD 93) can be attached to the expansion board 200 while the management and configuration of the sensor sets (90-93) is conducted through the optional IEEE 1451.0 communication stack. In other words, each of the sensor sets (90-93) is conducted to each of the TCh₀-TCh₃ (70-73).

An individual set of TEDS (according to the Dot0 standard, each set is consisting on: Transducer Channel TEDS, Calibration TEDS, and User's Transducer Name TEDS) is connected to each attached sensor. The set of TEDS is connected to each of the Transducer Channel TCh₀-TCh₇ (70-77) by the Dot0 framework. In such manner, the TChₓ's associated set of TEDS each sensor (90-93 in the suite example) is completely defined. TEDS access is obtained through the Dot0 set of commands. After reading the TChₓ's TEDS set (for example during the initialization process), the specifications of the corresponding sensor are known. This scheme the CRE-SSN provides self-identification capability for each attached sensor and the TIM.

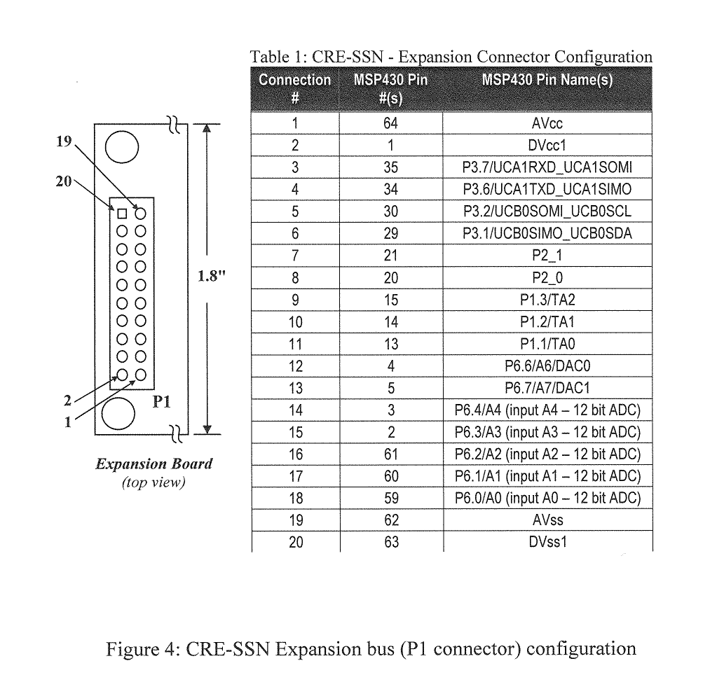

In order to achieve the baseline for the two-board stack of CRE-SSN, the signal conditioning 203 (22 in the CRE-SSN architecture depicted in FIG. 1: to handle a different sensor suite) and communication module 202 (30 in the CRE-SSN architecture depicted in FIG. 1) are able to swap, which are hosted within the expansion module 200. Accordingly, the realization of the two-board stack of CRE-SSN is enable by: (a) populating the signal conditioning 203 according to the CRE-SSN's requirements considering a given application (where sensor suite and signal condition can be set according to the system requirements); and (b) by designing the expansion boards 200 (where the baseline Zigbee communication module can be replaced) in compliance with the expansion bus 201, whose configuration is defined in FIG. 4. As defined in FIG. 4, the expansion bus 201 provides access to GPIO, AID channels, powering (digital and analog), digital to analog conversion (DAC), timers, and core serial communications, such that some signals are multiplexed, wherein the selection of the delivered signal (output signal in the connector's pin) is conducted by software.

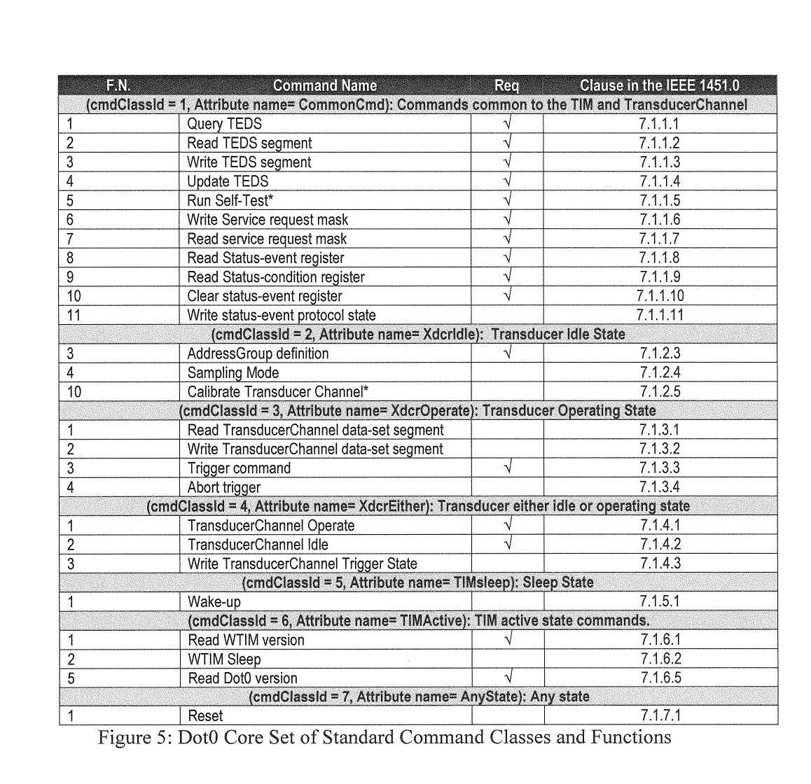

FIG. 2 shows that the CRE-SSN architecture 10 and its implementation have the capability of operating in conjunction with the remote Network Capable Application Processor (NCAP) 50. The microcontroller 36 of CRE-SSN dedicated to performing data acquisition, executing IEEE 1451 commands (listed in FIG. 5), and performing intelligent functions such as: (a) sensor preprocessing; (b) diagnostics; (c) learning; (d) calibration; (e) data-validation; (f) self-healing (cluster of sensors); and (g) self-identification. Key characteristics of the CRE-SSN 10 are: (a) compliance with the Dot0 standard; (b) used of a standard API (also provided by the standard); (c) awareness mechanism built upon baseline Dot0 capabilities; (d) able to have pattern recognition by Artificial Neural Network; and (e) a stand-alone operation. Therefore, implemented resources to provide these capabilities includes:

(1) Operation capability as Raw Sensor. Since the standardized software communication stack 60 is optional, the CRE-SSN 10 can be used as data collection system for accessing to communication interfaces 202 and 107 (wireless 30 and/or wired 34 respectively in the CRE-SSN architecture depicted in FIG. 1), sensor suite connections 204-211 (21 in the CRE-SSN architecture 10 depicted in FIG. 1), and signal conditioning 203 (22 in the CRE-SSN architecture depicted in FIG. 1). A serial communication profile is able to conduct to access the communications interface 202 (30 in the CRE-SSN architecture). The serial communication profile enables for changing the baseline Zigbee Module for any other module that operates with asynchronous serial communication according to specific application requirements (communication). Sensor suite connections 204-211 and the Transducer Channels 70-77 are adapted for attaching selected set of sensors (suite) in the expansion board 200. Then, the microcontroller 36 can be used for processing sensor data from sensor suit connections 204-211 and managing communication module 30.

(2) Deployment in Modular or Standalone Fashion. The CRE-SSN 10 and a power source can be deployed for standalone configuration. A second alternative is stacking sets of CRE-SSN with a common power bus to up-scale the individual CRE-SSN capabilities within a single module.

(3) Optional Embedded Version of a Communication Protocol based on an IEEE 1451 Set of Commands (indicated as required by the standard) and Related Resources Defined by the Standard. Optional software communication stack 60 has been designed to manage networks of CRE-SSN or a single CRE-SSN. According to the Dot0 standard in the CRE-SSN, a layer shape software structure (depicted in FIG. 2) includes: (a) a WTIM IEEE 1451.x communication module 61 (being the baseline of the Zigbee-IEEE 802.15.4 (202)); (b) TIM IEEE 1451 services 63; (c) TEDS 62 arranged within the IEEE 1451 services 63; and (d) a sensor signal processing functions 64 having a output data stream, a signal conditioner, a data conversion and a IEEE TEDS reader library. The Network Capable Application Processor (NCAP) 50 has a similar software stack structure (to provide NCAP functionality according to the Dot0 standard), which includes: (a) a NCAP IEEE 1451.x communication module 53 (Zigbee-IEEE 802.15.4); (b) NCAP IEEE 1451 services 52; and (c) NCAP application layer 51. The addressing mode of the CRE-SSN id defined by following the Dot0 convention. Data packages and commands are transferred via messages in compliance with the Dot0 standard. The embedded command set (as shown in FIG. 5) includes commands in the following seven classes: (i) “Commands Common to the TIM and Transducer Channel”, command class ID (cmdClassId)=1; (ii) “Transducer Idle State Commands”, cmdClassId=2; (iii) “Transducer Operating State Commands”, cmdClassId=3; (iv) “Transducer either Idle or Operating State Commands”, cmdClassId=4; (v) “Sleep State Commands”, cmdClassId=5; (vi) “TIM Active State Commands”, cmdClassId=6; and (vii) “Any State Commands”, cmdClassId=7.

FIG. 5 shows a Dot0 standard table according to the preferred embodiment of the present invention, wherein the Dot0 standard table includes: (a) the Function Number (F.N. first column); (b) the command name (second column); (c) required or not required by the standard (third column); and (d) the standard's clause in the IEEE 1451.0. The optional Dot0 software communication stack 60 is available for both the CRE-SSN and host computer (this last acting as the NCAP). For each class, set of implemented commands are defined in the second column of the table (FIG. 5) as follows:

(a) Transducer Idle State Commands: Query TEDS, Read TEDS segment, Write TEDS segment, Update TEDS, Run Self-Test, Write Service request mask, Read service request mask, Read Status-event register, Read Status-condition register, Clear status-event register, Write status-event protocol state.

(b) Transducer Idle State Commands: Address Group definition, Sampling Mode, Calibrate Transducer Channel.

(c) Transducer Operating State Commands: Read Transducer Channel data-set to segment, Write Transducer Channel data-set segment, Trigger command, Abort trigger.

(d) Transducer either Idle or Operating State Commands: Transducer Channel Operate, Transducer Channel Idle, Write Transducer Channel Trigger State.

(e) Sleep State Commands: Wake-Up.

(f) TIM Active State Commands: Read WTIM version, WTIM Sleep, Read Dot0 version

(g) Any State Commands: Reset.

The CRE-SSN software implementation allows embedding the full set of listed commands or reduced set of the listed commands as mentioned above. Implementation of the “Run Self-Test” (in the Transducer Idle State Command subset) and “Calibrate Transducer Channel” (in the Transducer Idle State Commands subset) are dependent of the attached sensor suite and the realization of the capabilities subset of the CRE-SSN. These hardware dependent commands are declared in the software and are available for customization (the user can write the required functionality within the function body).

The optional Dot0 software communication stack 60 is available for both the CRE-SSN and host computer (this last acting as the NCAP).

(4) Enhanced Dot0 Communication Software Portability for Diverse Physical Channels between NCAP IEEE 1451.x communication module 53 and WTIM IEEE 1451.x communication module 61. In order to access to the Communication Module 30 (202 in the two-board baseline implementation), the serial communication profile is provided to enable the execution of the Dot0 communication stack 60 through different physical channels (such as Zigbee, Bluetooth, or IEEE 802.11). Therefore, data formats containing commands and respond messages are transferred through the physical channel of the serial communication profile (i.e. the communication process is independent and not affected by the physical layer implementation as long as it is driven by serial communication profile).

(5) Design and Implementation of a Flexible Architecture for Customization System. The CRE-SSN baseline architecture consists on: (i) a main board 100, which provides a digital core; (ii) expansion (secondary) board 200 to enable a customization sensor; and (iii) an expansion bus 105, which provides access to I/O modules in the microcontroller 36 (as defined in FIG. 4). The architectures of the system can be realized in a single board or board stacks (where boards are designed according to the expansion bus definition (FIG. 4's table)).

According to the preferred embodiment of the present invention, a two-board implementation is shown in FIG. 3.a and FIG. 3.b, where the core capabilities of the main board 100 includes: (a) to select different power sources (primary AC/DC converter 101; battery 102; and a third optional configurable power source 102); (b) a serial communication (RS-232) connection 103; (c) a JTAG connection 104; and (d) a Digital Input/Output, timers, DAC, and ADC channels, which are available throughout the expansion connector 105.

The two-board customization implementation sensor is enabled by the expansion board 200 (connected in a stack board fashion). The expansion connector 105 provides access to the Digital Input/output and analog channels, as defined in FIG. 4 and further to the secondary board 200 through its bus connector 201. An optional Zigbee module 202 and connection to external sensors (transducers) are also available by standard connectors 204-211. Custom modules can be designed to meet specific system requirements by working with this architecture and for compliance with the expansion bus based on the MSP430 input/output modules. Since input/output modules are already available in the digital core, the bus is scalable, which allows system implementation by using a subset of the signals provided in the expansion bus. Because the communication module is designed for the operation with a Serial Communication Profile, the baseline communication module can be replaced with any other module that can be driven by an asynchronous serial communication.

(6) Designed for meeting the SWAP design requirements. The CRE-SSN architecture 10 consists of an ultra-low power solution with miniaturized form factor. The CRE-SSN dimensions (baseline sensor) are 1.82″×1.82″×1.25″ considering an external casing. The dimension of the expansion board 200 can be increased to host bigger signal conditioning circuits. The CRE-SSN architecture 10 can be also implemented in a single board. The digital core (main board 100 in the two-board realization) provides: powering 101-102; wired RS-232 communications 103; and JTAG 104.

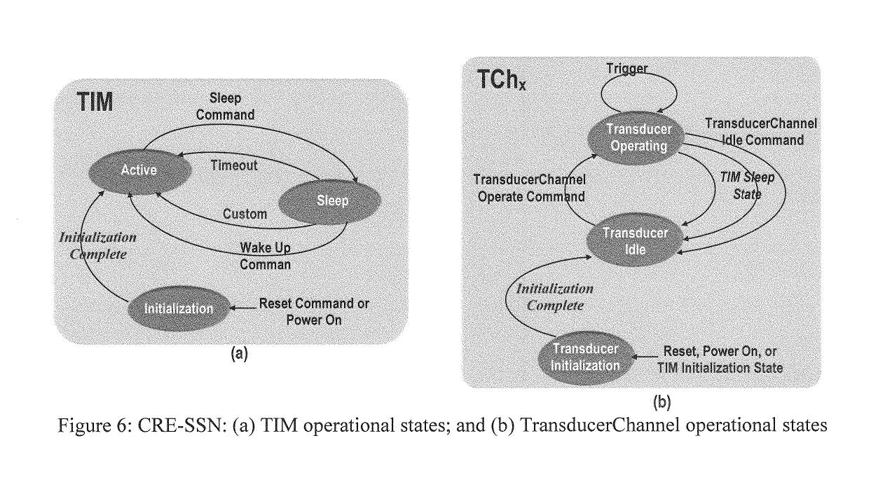

(7) Optional Standardized Operation modes for the CRE-SSN and Transducer Channels. When Dot0 Software Stack 60 is enabled, the Dot0 Software Stack 60 of the CRE-SSN 10 can operate (as depicted in the left oval in FIG. 6 and defined by the Dot0 standard) in the states of : (a) active; (b) sleep; and (c) initialization. Also, the Dot0 software communications stacks 60 of each Transducer Channel 70-77 can operate (as depicted in the right oval of FIG. 6 and defined by the Dot0 standard) in the states of: (a) Operating; (b) idle; and (c) initialization.

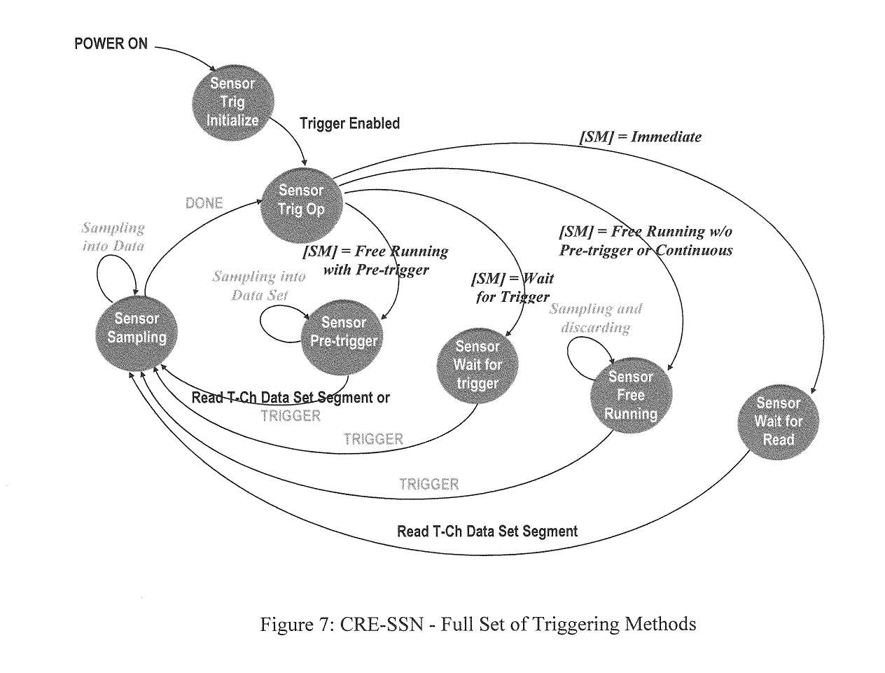

(8) Optional Reconfigurable triggering schemes to start sampling. When Dot0 Software Stack 60 is enabled, the Dot0 Software Stack 60 of the CRE-SSN 10 can be triggering by a set of schemes as depicted in the right oval of FIG. 7 and defined by the Dot0 standard.

(9) Optional Reconfigurable Sampling Modes. When Dot0 Software Stack 60 is enabled, the Dot0 Software Stack 60 of the CRE-SSN 10 provides a set of sampling modes consisting on: (i) individual samples; (ii) set of samples (sequence); and (iii) buffering schemes. Sampling modes are implemented according to the definitions provided by the Dot0 standard. If the Dot0 Software Stack 60 is not enabled, a fix sampling mode can be set for the operation of the CRE-SSN 10.

(10) Based on the Transducer Embedded Datasheet (TEDS). Characteristics of the selected transducer attached to the Transducer Channel 70-77 can be conducted by TEDS 62 as defined by the Dot0 standard. Five types of the TEDS are used within the CRE-SSN: (1) Meta-TEDS; (2) PHY-TEDS; (3) User's Transducer Name TEDS (or “XderName”); (4) Transducer Channel TEDS (or “ChanTEDS”); and (5) Calibration TEDS (or “CalTEDS”). The first four types of the TEDS are required by the standard definition. In the CRE-SSN, the overall TIM's attributes are defined by a set of TEDS consisting on the Meta-TEDS, PHY-TEDS, and User's Transducer Name TEDS. Each TIM's channel is associated to a different set of TEDS that enables self-identification of each sensor suites attached on the Transducer Channel 70-77. In the CRE-SSN, each Transducer Channel 70-77 is associated to a set of TEDS which is composed of Transducer Channel TEDS, Calibration TEDS, and User's Transducer Name TEDS. In this way, the overall characteristics of the CRE-SSN 10 (and. Universal Unique Identification (UUID), embedded within the Meta-TEDS) are defined in the TIM's TEDS set, such that the characteristics of each channel and associated transducer are defined by the TCh's TEDS set.

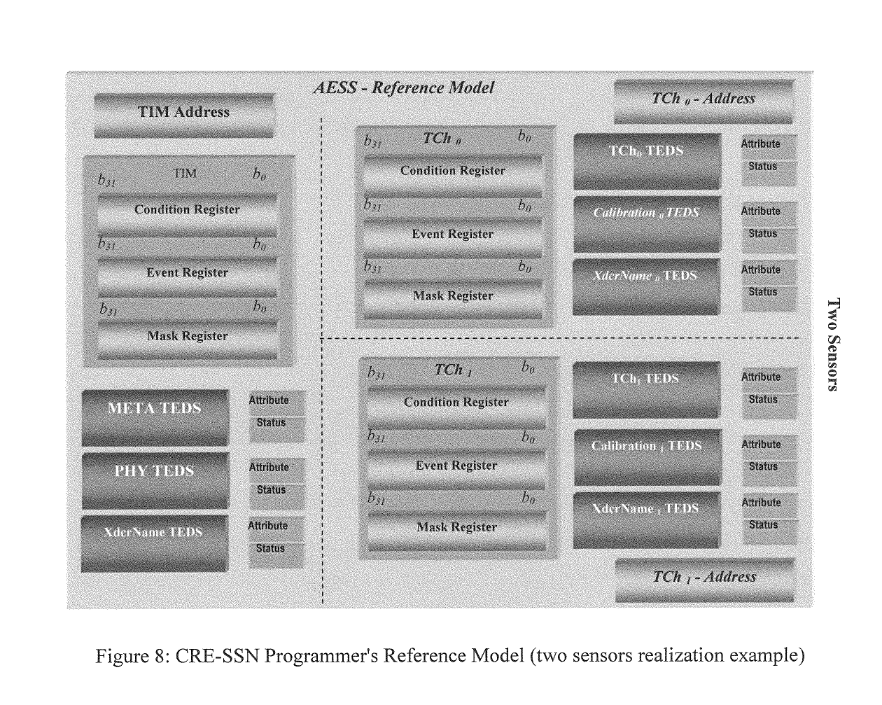

(11) Programmer Reference Model and Sensor Self-Identification. Specifications of the CRE-SSN 10 (i.e. as a TIM) can be conducted by TEDS 62. Specifications of each TIM's TCh are also defined by a set of TEDS. In such manner, each common characteristics of the CRE-SSN 10 to the whole device as well as transducer attached to the CRE-SSN Transducer Channel 204-211 can be completely defined to enable self-identification. In order to incorporate with the TEDS and be based on the Dot0 standard, the related registers for its management are provided within the software stack. A programmers reference model (based on the Dot0 definition) is provided in FIG. 8 showing the TEDS associated to the overall TIM (left side of the figure, in the left side of the vertical dashed line), and the ones associated to two channels (right top side and right bottom side) as an example of a TIM with two sensors

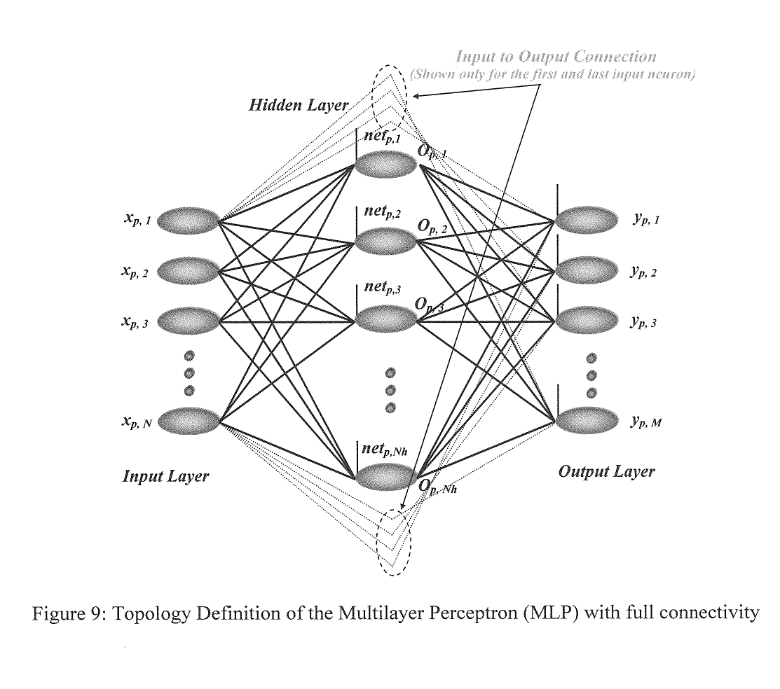

(12) Reconfigurable Evolutionary Algorithm Implementation by Artificial Neural Network (ANN) Design and a Standardized Framework. A two level distributed machine learning scheme is enabled. Specifically, high-level functions (evolutionary algorithms) can be integrated into the host computer (software tools in the NCAP application layer 51) for designing ANNs with different learning paradigms and collaborative behaviors. Therefore, the ANNs as mentioned above can then be transferred and embedded in the ultra-low power CRE-SSN. FIG. 9 provides the topology of a Multilayer Perceptron (MLP), wherein the MLP topology is defined by the number of inputs (N), number of hidden layers (one hidden layer in FIG. 9), number of neurons (Nₕ) in each hidden layer, number of outputs (M), and whether or not that there are connections between non-adjacent layers (input to output in FIG. 9). Since the CRE-SSN Intelligent Software Elements (ISE) consisting of Artificial Neural Networks (ANN) can be deployed after training in the NCAP. The ISE includes the MLP (other ANN can be managed following the same scheme). The CRE-SSN considers a network with three layers (as defined in FIG. 9) with an input layer of N neurons, a hidden layer of Nₕ neurons, and an output layer of M neurons and the connections between the input layer and output layer (which is referred to as full connectivity), although only connections between the first and last input neuron are shown in the figure for clarity.

(13) Weight and bias values between neurons. Weight values represent the synapses effects between neurons. A weight value is required for each connection between each neuron (for example, the blue lines between the input neurons x_{p, k} (where 1≦k≦N) and hidden units in the middle layer in FIG. 9. There will be connections between: (a) the input neurons and hidden layer; (b) the hidden layer and output layer; and (c) the input layer and output layer (since full connectivity is considered). Bias values are assigned to each unit in the hidden and output layer (depicted by the vertical line on the left of each neuron in FIG. 9). Then, two matrices are required: (a) a first one is to define the weights between the input and hidden layer and bias, with a size of (Nₕ×(N+1)); and (b) a second one is to define the values of the weights between the “input and hidden layer's neurons” with the “output layer's neurons”, with a size of M×(N+Nₕ+1).

It is worth mentioning that an MLP (ISE) is fully defined by a data structure containing a topology definition by working with this topology and weight matrices, such that the MLP (ISE) represented as:

MLPᵢ={Nᵢ,Nhᵢ,Mᵢ,Wᵢ,Woᵢ}

where: (a) Nᵢ is the number of inputs for the i^{th} MLP; (b) Nhᵢ is the number of hidden units for the i^{th} MLP; (c) Mᵢ is the number of output units for the i^{th} MLP; (d) is the input weight matrix that contains the bias and weights that exist between the input neurons and the neurons in the hidden layer for the i^{th} MLP; and (e) Woᵢ is the output weight matrix that contains the bias and weights that exist between the “input neurons and hidden neurons” with the “output neurons” in the i^{th} MLP. Then, the i^{th} MLP can be trained in the NCAP, and as a result the ANN weights and bias (contained in the Wᵢ and Woᵢ matrices) are obtained. Next, the associated MLPᵢ structure can be transferred into the CRE-SSN and the trained i^{th} MLP can be used for processing new input vectors (obtained from the sensor suite) and executing intelligent health monitoring functions during the CRE-SSN operation.

(14) Reconfigurable Advanced Embedded Intelligent Functions. The CRE-SSN and host computer (NCAP when executing the Dot0 software stack) provide an advanced framework for deploying intelligent functions within target systems. In addition, trained ANN provides the building blocks for implementing Failure Detection and Identification (FDI) schemes. The NCAP controls the advanced functions, and then the resulting networks are embedded within the sensors by transferring the NN data structures (weight matrices and bias vectors) and topology (layer number and units per layer) to the CRE-SSN.

(15) Optional Asynchronous Awareness Mechanism enabled by the Dot0. When the Dot0 Software Stack 60 is enabled, the Dot0 Software Stack 60 TIM (CRE-SSN 10) initiated messages may be sent to the NCAP by using the standard's Status-Event Protocol State (as defined by the Dot0). In the CRE-SSN, this Dot0 capability has been used to develop fault awareness mechanism for transmitting fault information to the user in an automated way. Due to having this Dot0 framework (Status-Event Protocol State), the fault awareness mechanism combines ANN failure detection capability with the IEEE 1451.0 capabilities. When a fault condition is detected by using the sensor node's embedded ANN, bits 23 to 25 in the CRE-SSN's condition, the status event registers are updated (shown in FIG. 8). Since the Status-Event Protocol State is enabled, the sensor can generate and transmit to the NCAP (and MMI) by a message in a 1451.0 (containing the content of the condition register) format indicating a fault.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A reconfigurable embedded smart sensor node customizable to different form factors, comprising:
a communication module, a processing unit using an ultra-low-power microcontroller and complementary resources including a reconfigurable RS-232 serial port wired interface, a power management unit, and JTAG port 35;
a rich set of optional software resources to implement the functionalities of Network Capable Application Processor (NCAP) and Transducer Interface Module (TIM); and
a two-board stack consisting of a main board hosting digital cores; and an expansion board having a customizable signal conditioning, a plurality of sensor suite connections, an expansion bus and a communication module for baseline implementation.

2. The reconfigurable embedded smart sensor node, as recited in claim 1, further comprising sets of switchable sensors suites with a baseline for system reconfiguration, which can be formed by same or different transducer type and up to seven sensors suites can be hosted through said expansion board under the baseline CRE-SSN implementation.

3. The reconfigurable embedded smart sensor node, as recited in claim 2, wherein said sets of switchable sensor suites can be configured through transducer Channels, by taking advantage of said TIM software resources.

4. The reconfigurable embedded smart sensor node, as recited in claim 1, wherein said digital cores comprise an ultra-low power microcontroller such as MSP430F2618, an ultra-low-power RS-232 driver, a 9-pin connector, a JTAG connector and an expansion bus connector.

5. The reconfigurable embedded smart sensor node, as recited in claim 1, wherein said main board has a battery providing 3 volts DC for powering said CRE-SSN.

6. The reconfigurable embedded smart sensor node, as recited in claim 1, wherein said main board has a LDO regulator electrically connected to a 12 volts DC for powering said CRE-SSN.

7. The reconfigurable embedded smart sensor node, as recited in claim 2, wherein said customizable signal conditioning and said sensor suite connections are adapted for integrating said sensor suites formed by up to seven homogeneous or heterogeneous sensor sets.

8. The reconfigurable embedded smart sensor node, as recited in claim 1, wherein the dimensions of said two-board stack are 1.82″×1.82″×1.25″ considering an external casing.

9. The reconfigurable embedded smart sensor node, as recited in claim 3, wherein Transducer Interface Module of said CRE-SSN can operate in the states of active, sleep, and initialization when enabled the optional Dot0 communication stack.

10. The reconfigurable embedded smart sensor node, as recited in claim 3, wherein Transducer Channel of said CRE-SSN can operate in the states of operating, idle, and initialization when enabled the optional Dot0 communication stack.

11. The reconfigurable embedded smart sensor node, as recited in claim 1, wherein said reconfigurable embedded smart sensor node can operate as a raw sensor system.

12. The reconfigurable embedded smart sensor node, as recited in claim 1, wherein said transducer interface module of the CRE-SSN can be triggering by a set of schemes and defined by the Dot0 standard, when enabled the optional Dot0 communication stack.

13. The reconfigurable embedded smart sensor node, as recited in claim 1, wherein said transducer interface module provides a set of sampling modes consisting of individual samples, set of samples (sequence), and (iii) buffering schemes while said transducer interface module is enabled.

14. The reconfigurable embedded smart sensor node, as recited in claim 1, wherein standardized commands, operation states, and triggering schemes can be used for managing sensor suites and sampling process, when enabled the optional Dot0 communication stack.

15. The reconfigurable embedded smart sensor node, as recited in claim 1, wherein the Dot0 framework is adapted for self-identification by embedded the TEDS of the Dot0.

16. The reconfigurable embedded smart sensor node, as recited in claim 1, wherein the overall attributes of TIM attributes are defined by a set of TEDS, which is Meta-TEDS, PHY-TEDS, User's Transducer Name TEDS (or “XdcrName”), Transducer Channel TEDS (or “ChanTEDS”), and Calibration TEDS (or “CalTEDS”).

17. The reconfigurable embedded smart sensor node, as recited in claim 1, wherein an Artificial Neural Networks (ANNs) ANNs as transferred and embedded in the ultra-low power CRE-SSN provides a baseline topology of a Multilayer Perceptron (MLP), wherein said MLP topology is defined by the number of inputs (N), number of hidden layers, number of neurons (Nₕ) in each hidden layer, number of outputs (M), and whether or not that there are connections between non-adjacent layers.

18. The reconfigurable embedded smart sensor node, as recited in claim 17, wherein said MLP is fully defined by a data structure containing a topology definition by working with this topology and weight matrices, such that the MLP (ISE) can be represent as:
MLPᵢ={Nᵢ,Nhᵢ,Mᵢ,Wᵢ,Woᵢ}
wherein (a) Nᵢ is the number of inputs for the i^{th} MLP; (b) Nhᵢ is the number of hidden units for the i^{th} MLP; (c) Mᵢ is the number of output units for the i^{th} MLP; (d) is the input weight matrix that contains the bias and weights that exist between the input neurons and the neurons in the hidden layer for the i^{th}MLP; and (e) Woᵢ is the output weight matrix that contains the bias and weights that exist between the “input neurons and hidden neurons” and the “output neurons” in the i^{th} MLP.

19. The reconfigurable embedded smart sensor node, as recited in claim 18, wherein said ANN provides building blocks for implementing Failure Detection and Identification (FDI) schemes.

20. The reconfigurable embedded smart sensor node, as recited in claim 19, wherein said NCAP controls the advanced functions, and then the resulting networks are embedded within said sensor sets by transferring the NN data structures (weight matrices and bias vectors) and topology (layer number and units per layer) to said CRE-SSN.

21. The reconfigurable embedded smart sensor node, as recited in claim 1, wherein initiated messages from Transducer interface module can be send to said NCAP by using the standard's Status-Event Protocol State, wherein the Dot0 capability has been used to develop a fault awareness mechanism for transmitting fault information to the user in an automated way, when enabled the optional Dot0 communication stack.

22. The reconfigurable embedded smart sensor node, as recited in claim 21, wherein said fault awareness mechanism combines ANN failure detection capability with the IEEE 1451.0 capabilities, wherein when a fault condition is detected by using the sensor node's embedded ANN; bits in the CRE-SSN's condition, the status event registers are updated.

23. The reconfigurable embedded smart sensor node, as recited in claim 21, wherein the sensor can generate and transmit to said NCAP (and MMI) by a message in a 1451.0 format indicate a fault while said status-event protocol state is enabled.

24. The reconfigurable embedded smart node, as recited in claim 1, when enable the optional Dot0 communication stack, provides a serial communication profile (frame of data bytes sent in serial format) independent of the actual physical communication medium. Streams of data according to the Dot0 standard definitions are sent in serial to communication device. The streams of data are converted within the communication device to the appropriate physical medium for transmission. In the reception the communication device extract data from the physical medium and delivers a serial data stream. The coordinator interface (NCAP) performs complementary functions during communication;

25. The reconfigurable embedded smart node, as recited in claim 24, provides a scheme where Wireless Communication interfaces (physical layer) can be interchanged without affecting the operation of the Dot0 communication stack, which is enabled by a serial communications profile, expansion bus, and microcontroller.
